(19) United States
(12) Patent Application Publication
(10) Pub. No.: US 2019/0335941 A1
(43) Pub. Date: Nov. 7, 2019

(54) CAPSULE WITH SEALING RETENTION AND SYSTEM FOR PREPARING EDIBLE PRODUCTS BASED UPON SAID CAPSULES

(71) Applicant: NOVADELTA - COMERCIO E INDUSTRIA DE CAFES, S.A., Lisboa (PT)

(72) Inventors: Rui NABEIRO, Campo Maior (PT); Joao Andre DE FIGUEIREDO BRANCO, Moscavide (PT); Jesus MEDINA MUNDT, Lisboa (PT)

(73) Assignee: NOVADELTA - COMERCIO E INDUSTRIA DE CAFES, S.A., Lisboa (PT)

(21) Appl. No.: 16/473,703

(22) PCT Filed: Dec. 27, 2017
(86) PCT No.: PCT/PT2017/050033

§ 371 Date: Jun. 26, 2019

(30) Foreign Application Priority Data
Dec. 29, 2016 (PT) 109816

(51) Int. Cl. A47J 31/40; B65D 85/804

(52) U.S. Cl. CPC A47J 31/407; B65D 85/8043

(57) ABSTRACT

A capsule (1) comprising a first construction element (2) having a container-like shape, and a second construction element (3) having a lid-like shape, adapted to contain an individual portion of an edible substance. The second construction element (3) has a passageway wall (4) surrounded in at least most part of respective perimeter by a weakened material region (41). The element (3) also has a recess region (5) and intercalary region (6) that provides a better retention of the capsule (1) and upstream sealing of the pressurized flow inside of a brewing device (10). The capsule (1) is part of a system for preparing edible products, including the capsule (1), an apparatus for preparing edible products comprising at least one brewing device (10) presenting one engagement element (15) adapted to engage with said recess region (5), so as to retain said capsule (1) with relation to a sealing element (14) provided so as to be adjacent with said intercalary region (6).

### FIELD OF THE INVENTION

The present invention refers to the field of the capsules for preparing edible products including aromatic beverages, such as for example espresso coffee, tea and similar.

The present invention further refers to a system for preparing edible products based upon capsules.

### BACKGROUND OF THE INVENTION

The prior art includes several solutions relating to systems for preparing beverages, such as for example machines for preparing beverages including espresso coffee, tea and similar, based upon capsules containing a single portion of edible substance and provided so that are collected inside of a brewing device. Said brewing device is adapted so as to inject a pressurized fluid flow through an upstream side of capsule, and to collect the resulting beverage from a downstream side of capsule.

In particular in the case of capsules provided in a substantially rigid material and construction structure, despite being retained by means of pressured engagement inside of a respective brewing device, this type of capsules can slip a direction transversal to the prevailing flow direction, notably in a rotation movement around its axial axis, in particular in case that the pressurized water injection is not done by means of penetration of the capsule envelope. In fact, in the case of brewing devices with multiple pressurized water injection outlets, there is the need to ensure that a capsule of this type is retained in reliable manner, and eventually positioned on a given angular position, inside of a respective brewing device.

The document EP 2287090 B1 discloses a capsule comprising a container part with a base wall that presents a structure that forms a reduced thickness of entry wall of the pressurized fluid. In particular, said structure forms a continuous annular recess portion of radius R1 where there is provided a plurality of injection holes.

The document EP 2394932 B1 discloses a capsule similar to that of the aforementioned document, whereby in this case there is provided a weakened material region designed such that breaks at least partially under the pressure of a pressurized liquid. Moreover, the body of the capsule is made of plastic or from a plastic based material.

The document FR 2905683 A1 discloses a capsule provided with a recess of circular shape on the flow entry side, comprising a plurality of inlets for entry of pressurized water, so as to prevent the deterioration of the container as a result of perforation thereof. O document further discloses a pressured-fitting engagement between two construction elements of the capsule, provided on the top face that is opposite to the one where said recess is provided.

The document EP 1950150 B1 discloses means for recognizing contents of a capsule for preparing beverages. In particular, the capsule presents a plurality of recesses provided on a surface adapted for entry of flow and configured so as to engage with corresponding recognition means provided in the form of a mechanic displacement probe. Said mechanic probe means operate based upon a relative displacement, eventually subject to a major wear after a given operating period. This solution does not structurally reinforce the connection between the two main construction elements of the capsule.

The document EP 2757057 A1 discloses a capsule that presents a groove that surrounds the central region that presents at least one perforation zone with perforations that provide inlet of hot water to the interior of the capsule.

The document WO 2015/002562 A1 submitted by the author of the present application discloses a capsule comprising a lid-like element that presents at least one engagement groove disposed such that is surrounded by, or itself surrounds, a zone of said second construction element adapted for fluid passage. However, this engagement groove is provided in the proximity of lid perimeter, and provides a capsule that presents an additional resistance to the pressure forces to which it is submitted in a beverage preparation process, in particular in view of a reduction of wall thickness at least of the top wall and of a use of mechanic means of assembly of said construction elements, optimized so as to enable a manual closure of the capsule.

### General Description of the Invention

The objective of the present invention is to provide a capsule in a substantially rigid construction, for collection of a single portion of an edible substance, in particular adapted for preparing edible products, including beverages, inside of a respective brewing device, and that provides a better entry of pressurized flow through a respective upstream oriented wall.

This objective is solved by means of a capsule according to claim 1, and preferred embodiments are disclosed in the dependent claims.

In particular, the aforementioned objective is attained by means of a capsule that comprises lid-like construction element, presenting a flow entry wall part that presents a passageway wall provided as a recess of circular shape and further a recess region of ring shape provided on the upstream oriented side of said flow entry wall part, whereby said recess region develops from a second circumferential alignment in the proximity of said passageway wall and so that defines an intercalary region between said recess region and said passageway wall, whereby said recess region presents a recess wall thickness that is smaller than the prevailing wall thickness, and bigger than the passageway wall thickness of said passageway wall, so that structurally reinforces the region surrounding said passageway wall and provides retention surfaces for an engagement element provided on said brewing device.

This solution advantageously provides a retention of an engagement element of the brewing device in the vicinity region of said passageway wall and of a sealing element that surrounds the latter, so that improves the flow entry into the capsule.

The capsule according to the invention comprises a first construction element configured in a container-like form, and a second construction element configured in a lid-like form and adapted for entry of a pressurized fluid preferentially without holing of a respective exterior envelope, and adapted for joint assembly so as to provide an interior volume for collection of a portion of at least one edible substance, including coffee, tea and similar.

According to another inventive aspect, said intercalary region presents an intercalary wall thickness that is bigger than the passageway wall thickness of said passageway wall and bigger than the recess wall thickness of said recess region, preferentially is at least approximately similar to said prevailing wall thickness, thereby structurally reinforcing the region surrounding said weakened material region and providing a support surface to a sealing element provided on said brewing device.

This solution advantageously provides a support for a sealing element in the brewing device such that contains the pressurized fluid flow concentrate in the passageway wall of capsule, thereby improving the effectiveness of opening thereof.

An associated objective is to provide a capsule that provides better conditions of opening of a passageway wall presenting a weakened material region.

It is preferred when the upstream oriented surface of capsule presents a passageway wall provided as a recess region of circular shape on both sides of said flow entry wall part.

It is preferred when said passageway wall presents a passageway wall thickness that is smaller than said prevailing wall thickness, and the respective weakened material region is provided by means of localized reduction of said passageway wall thickness, so that results a region with a weakened thickness along said first circumferential alignment, thereby improving the opening of said passageway wall when impinged by an upstream pressurized flow.

It is preferred when said flow passageway wall is provided as a reduction of said prevailing wall thickness on a region of circular shape and disposed centred with relation to said flow entry wall part, and said weakened material region is provided between said prevailing wall thickness and said passageway wall thickness.

It is preferred when said passageway wall presents a passageway wall thickness that corresponds to a thickness reduction of said prevailing wall thickness of said flow entry wall part, provided on a region of circular shape and on both side of said flow entry wall part, so that said flow passageway wall develops on an intercalary plane between the exterior upstream and downstream oriented surfaces of said flow entry wall part.

Moreover, it is preferred when said passageway wall is surrounded downstream by a wall that extends beyond the plane defined by the wall thickness (e₃) of said flow entry wall part so that deflects the pressurized flow through the weakened material region, and in that at least said downstream surrounding wall, preferentially also an upstream surrounding wall of said passageway wall, develop along an oblique region relative to the direction of said axial axis (X).

It is preferred when said passageway wall is provided disposed closer to the upstream oriented surface than to the downstream oriented surface of said flow entry wall part.

It is preferred when said weakened material region is provided as the region between two recesses, on the upstream oriented side and on the downstream oriented side, of said passageway wall.

It is preferred when said weakened material region is provided as the region between two recesses in mutually opposing sides of said passageway wall, whereby said recesses present at least one of different shape and different dimension relative to the remaining passageway wall.

It is preferred when said weakened material region is provided as the region between two recesses in opposing sides of said passageway wall, developing along a circumferential alignment of at least approximately similar dimension, whereby in the region closest to each other said recesses distance of each other by a value corresponding to said weakened wall thickness.

It is preferred when said weakened material region is provided as the region between two recesses disposed in opposite side of said passageway wall, whereby said recesses present different depths relative to the surface planes of respective sides of said passageway wall, and said maximum depths develop in different projection along planes that are parallel to said axial axis (X).

It is preferred when said weakened material region is provided as the region between two recesses disposed in opposite sides of said passageway wall, whereby the recesses disposed on the upstream side develop at least partially on a more proximal region than the recesses disposed on the downstream oriented side, with reference to the axial axis (x) of said passageway wall.

It is preferred when said weakened material region is provided as the region between two recesses disposed in opposite sides of said passageway wall and presenting at least one oblique surface relative to the direction of said axial axis (X), whereby in the region closest to each other said recesses configure two surfaces oblique relative to the direction of said axial axis (X), and that develop at least approximately parallel along a rupture extension that presents said weakened material thickness and that develops oblique relative to the direction of said axial axis (X).

It is preferred when said weakened material region is provided along at least most part, preferentially the totality, of a circumferential perimeter and presents a first and a second weakened thickness, whereby said first weakened thickness is smaller than said second weakened thickness.

It is preferred when said weakened material region presents a first weakened thickness that develops along an arch of circumference comprised between 348° and 325°, preferentially between 345° and 328°.

It is preferred when said first weakened thickness is comprised between 0.05 and 0.20, preferentially between 0.10 and 0.15, of said passageway wall thickness of said passageway wall.

It is preferred when said passageway wall presents a projection element that develops upstream, whereby said projection element develops along an extension beyond the plane defined the upstream oriented surface of said flow entry wall part, so that can be impinged by a flow injection part of said brewing device.

It is preferred when said projection element is provided only on one side of said passageway wall relative to said axial axis (X), preferentially in the proximity of perimeter of said passageway wall.

It is preferred when said projection element develops along an extension comprised between 10 to 40°, preferentially between 15 and 35°, of the circumferential alignment that develops in at least approximately parallel manner relative to the circumferential alignment defined by the exterior limit of said passageway wall.

It is preferred when said projection element is provided in the proximity of the perimeter and on the side that develops in the weakened material region presenting a smaller wall thickness.

Another objective of the present invention is to provide a system for preparing edible products based upon capsules, presenting capsules and a brewing device adapted so as to improve the entry of flow into said capsules, in particular the concentration of pressurized flow on a passageway wall presenting a weakened material region.

This objective is solved according to claim 12, and preferred embodiments are disclosed in dependent claims.

An associated objective is to disclose a system that provides a better opening of a passageway wall presenting a weakened material region.

It is preferred when said injection means are provided as a projection developing downstream and adapted so that exerts a mechanic pressure upon part of said passageway wall in the proximity of said weakened material region, so that said passageway wall swivels downstream around a region of passageway wall opposite to said weakened material region as a result of said mechanic pressure.

It is preferred when said injection means are provided as a projection adapted so that at least part, preferentially at least most part of respective extension of projection develops inside the recess formed by said passageway wall on said flow entry wall part, when said brewing device is in a closed position.

It is preferred when said injection means are provided as a projection adapted so that exerts a mechanic pressure, preferentially in asymmetric manner, upon part of said passageway wall, in asymmetric manner relative to the form thereof and on a side opposite to that of a respective weakened material region.

It is preferred when said injection means are provided as a projection adapted so that exerts a mechanic pressure upon a projection element provided so that extends upstream and above and higher than said passageway wall, preferentially higher than said flow entry wall part.

### DESCRIPTION OF THE FIGURES

The present invention shall be hereinafter explained in greater detail based upon the description of preferred embodiments thereof and the Figures attached.

The Figures show, in simplified schematic representations:

FIG. 1: plan view (top) and side cut (bottom) of a capsule (1) according to prior art;

FIG. 2: plan view (top) and side cut (bottom) of a capsule (1) according to present invention;

FIG. 3: side-cut view of a first embodiment of second construction element (3) (top), and detail of a respective central region (bottom), of a capsule (1) according to the invention;

FIG. 4: plan view of the exterior face of second construction element (3) of the embodiment according to FIG. 3;

FIG. 5: side-cut view of a second embodiment of second construction element (3) (top), and detail of a respective central region (bottom), of a capsule (1) according to the invention;

FIG. 6: plan view of the exterior face of second construction element (3) of the embodiment according to FIG. 5;

FIG. 7: side-cut view of a third embodiment of second construction element (3) (top), and detail of a respective central region (bottom), of a capsule (1) according to the invention;

FIG. 8: plan view of the exterior face of second construction element (3) of the embodiment according to FIG. 7;

FIG. 9: side-cut view of a fourth embodiment of second construction element (3) (top), and detail of a respective central region (bottom), of a capsule (1) according to the invention;

FIG. 10: plan view of the exterior face of second construction element (3) of the embodiment according to FIG. 9;

FIG. 11: side cut views of a capsule (1) inside of a brewing device (10) in open position (left-hand side) and in closed position (right-hand side), of a system according to the present invention;

FIG. 12: front view of the upstream actuation part (11) of a brewing device (10) of a system according to the invention.

### DETAILED DESCRIPTION OF THE INVENTION

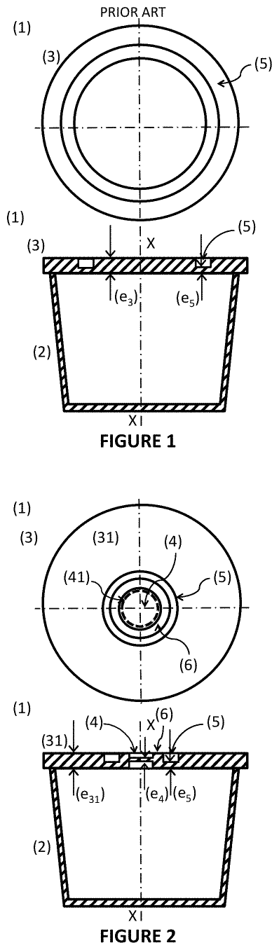

FIG. 1 represents a capsule (1) according to prior art, including a first construction element (2) configured in a container-like shape and a second construction element (3) configured in a lid-like shape. Said first and second construction elements (2, 3) are provided as substantially rigid, for example in a plastic material, and adapted for joint assembly along a common central axis (X) of said capsule (1), thereby providing an interior volume adapted for collection of a single portion of at least one edible substance, such as for example roasted ground coffee beans.

Said second construction element (3) presents a wall thickness (e₃) and a recess region (5) of ring shape in the upstream oriented surface thereof, whereby said recess region (5) presents a recess wall thickness (e₅) that is smaller than said wall thickness (e₃).

Moreover, said second construction element (3) comprises a flow entry wall part (31) that presents a generally disk-like shape with a prevailing wall thickness (e₃₁) defined between two planes transversal relative to an axial axis (X) of said flow entry wall part (31), whereby said flow entry wall part (31) is provided in a rigid material.

In the case of a capsule (1) according to the present invention (see FIG. 2), said recess region (5) is provided in the proximity of a passageway wall (4) provided with a circular shape that is delimited by a first circumferential alignment and disposed in centred manner relative to the axial (X) axis of said flow entry wall part (31), whereby said passageway wall (4) presents a weakened material region (41) that develops along at least most part of said first circumferential alignment and is adapted so that breaks when impinged by a pressurized upstream flow at a predetermined flow pressure.

In particular, according to an inventive aspect, said recess region (5) develops from a second circumferential alignment in the proximity of said passageway wall (4) and so that defines an intercalary region (6) between said recess region (5) and said passageway wall (4), whereby said recess region (5) presents a recess wall thickness (e₅) that is smaller than the prevailing wall thickness (e₃₁), and bigger than the passageway wall thickness (e₄) of said passageway wall (4), so that structurally reinforces the region surrounding said passageway wall (4) and provides retention surfaces for an engagement element (15) provided on said brewing device (10)—as shall be described in greater detail further below.

Moreover, according to another inventive aspect, said intercalary region (6) between said passageway wall (4) and said recess region (5), presents an intercalary wall thickness (e₆) that is bigger than the passageway wall thickness (e₄) of said passageway wall (4) and bigger than the recess wall thickness (e₅) of said recess region (5), preferentially is at least approximately similar to said prevailing wall thickness (e₃₁), thereby structurally reinforcing the region surrounding said weakened material region (41) and providing a support surface to a sealing element (14) provided on said brewing device (10).

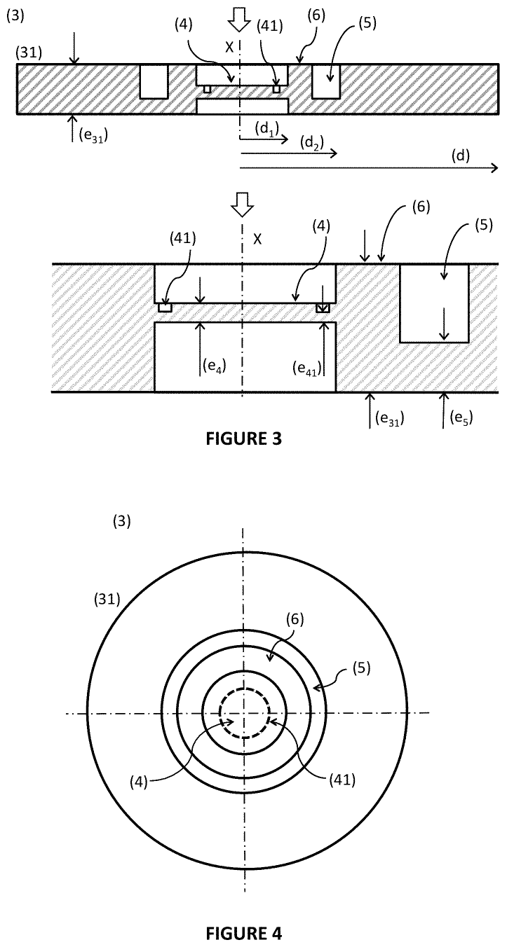

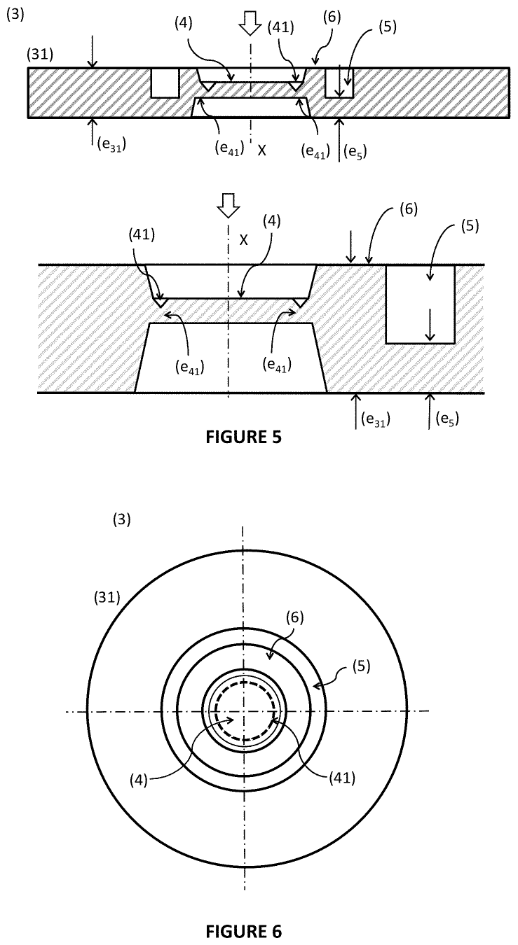

As can be better observed in FIGS. 3 and 4, at least most part, preferentially the totality, of recess thickness (e₅) of said recess region (5) develops between transversal planes in the proximity downstream of the transversal planes that delimit the passageway wall thickness (e₄) of said passageway wall (4), so that at least most part of said recess thickness (e₅) is provided downstream of said passageway wall thickness (e₄).

It is herewith provided a structural reinforcement of the region that surrounds said weakened material region (41), thereby advantageously improving the opening behaviour thereof as impinged by an upstream force.

In this respect, it is further preferred when said passageway wall (4) is delimited by a first circumferential alignment that presents a first diameter (d₁) smaller than 0.35 times the diameter (d) of said flow entry wall part (31), and when said recess region (5) is delimited on a respective distal side by a circumferential alignment presenting a second diameter (d₂), whereby said second diameter (d₂) is at least 1.2 times bigger, preferentially at least 1.4 times bigger, and at most 2.5 times bigger, preferentially at most 2 times bigger than said first diameter (d₁).

It has revealed itself as particularly advantageous when the radial extension of said recess region (5) is at least approximately similar, preferentially bigger than 0.8 times and smaller than 1.2 times the radial extension of said intercalary region (6).

Moreover, it is preferred when said recess region (5) presents a substantially polygonal transversal section defining at least three interior surfaces, preferentially five interior surfaces, and presenting a depth between 1 and 3 mm, preferentially between 1.5 and 2.5 mm, relative to the exterior surface of said second construction element (3), and a radial dimension between 1 and 3 mm, preferentially between 1.5 and 2.5 mm.

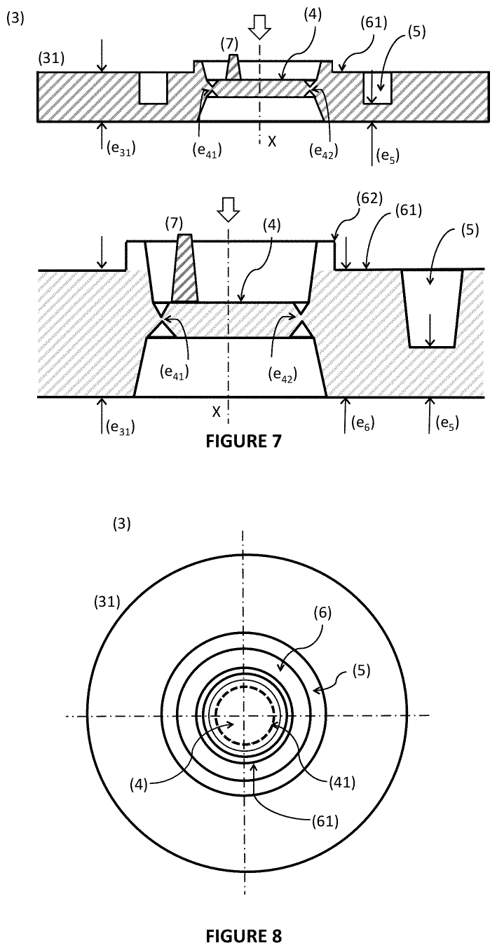

According to a preferred embodiment, represented in FIGS. 6 and 7, said recess region (5) presents a cross-section of trapezoidal shape with two inclined side surfaces.

Moreover, said intercalary region (6) presents an intercalary wall thickness (e₆) that develops between planes transversal to the axial direction upstream and downstream of the transversal planes that delimit said passageway wall thickness (e₄) and recess wall thickness (e₅).

In particular, as can be better observed in FIG. 7, said intercalary region (6) comprises a seat region (61) that develops in the upstream oriented surface of said flow entry wall part (31) along at least most part of the radial extension between said passageway wall (4) and said recess region (5), whereby said seat region (61) is adapted so that provides a seat surface to a sealing element (14) provided on said brewing device (10), as shall be described in greater detail further below.

It is further preferred when said seat region (61) presents a seat wall thickness (e₆₁) that is bigger than the passageway wall thickness (e₄) of said passageway wall (4), thereby improving the opening of said weakened material region (41) as impinged by an upstream pressurized flow.

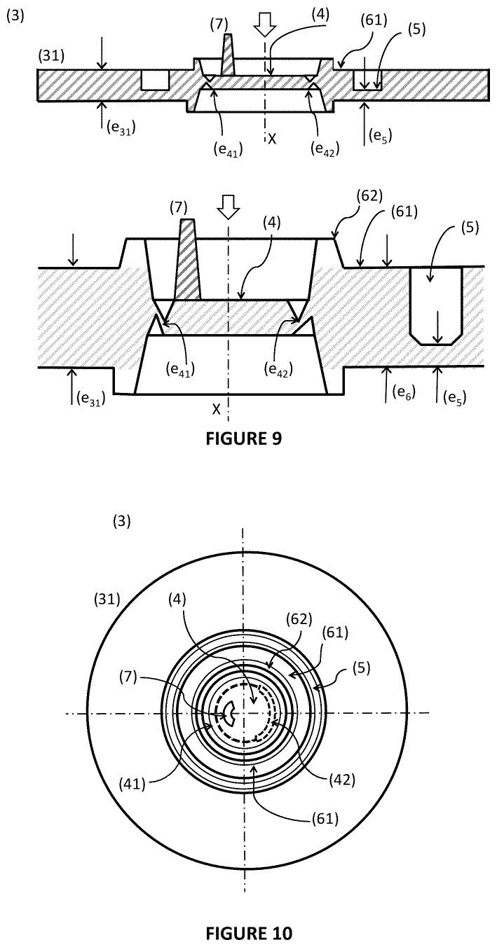

In the case of a fourth preferred embodiment (see FIGS. 8 and 9) of capsule (1), said recess region (5) presents a cross-section of regular polygonal shape with four side surfaces whereby at least two thereof are inclined.

As can be better observed in FIG. 9, said seat region (61) presents a seat wall thickness (e₆₁) that is bigger than the recess wall thickness (e₅) of said recess region (5), preferentially presents a wall thickness that is at least approximately similar to said prevailing wall thickness (e₃₁).

Moreover, it is further preferred when said intercalary region (6) presents a guiding projection (62) along said first circumferential alignment so that delimits said seat region (61) relative to said passageway wall (4), whereby said guiding projection (62) projects beyond the upstream oriented exterior surface of said flow entry wall part (31), so that provides a conduction surface that is adjacent and substantially orthogonal or oblique relative to the surface provided by said seat region (61).

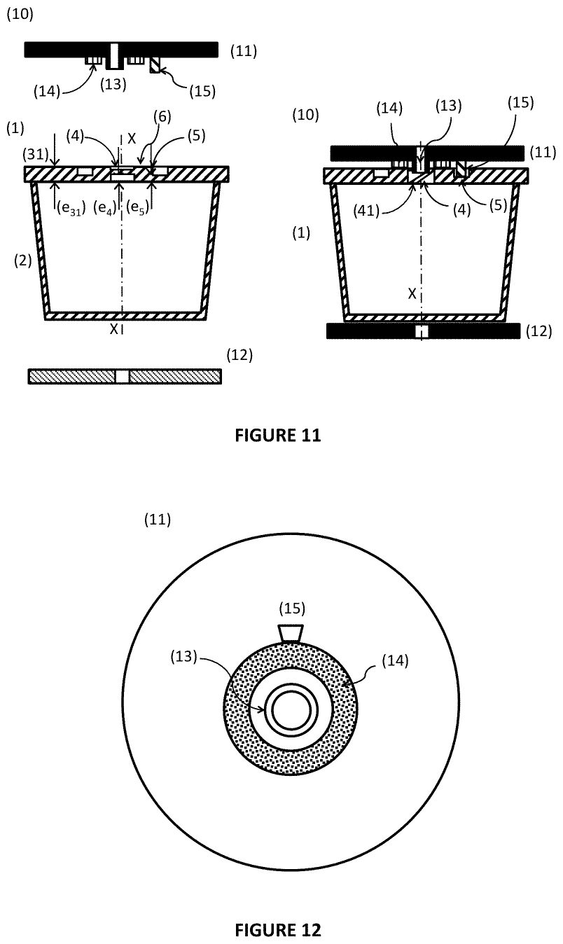

As represented in FIG. 11, a system for preparing edible products, in particular beverages, comprises a capsule (1) adapted for containing a single portion of an edible substance, an apparatus for preparing edible products based upon said capsule (1) and including at least one brewing device (10) that presents two actuation parts (11, 12).

It is known from prior art that said actuation parts (11, 12) are adapted so as to collect said capsule (1) and that at least one of said actuation parts (11, 12) can be moved relative to the other so as to engage with the exterior envelope of said capsule (1), an upstream actuation part (11) comprises injection means (13) adapted for impinging a pressurized fluid flow upon said passageway wall (4) provided on an upstream oriented side of said capsule (1), whereby a downstream actuation part (12) comprises discharge means adapted for collecting a beverage from the downstream oriented side of said capsule (1).

Moreover, said upstream actuation part (11) presents a sealing element (14) and one engagement element (15) adapted so as to cooperate with respective regions of flow entry wall part (31) of said capsule (1).

According to an inventive aspect, said upstream actuation part (11) further presents an engagement element (15) provided as a protuberance that develops at a distance from said injection means (13) and is adapted so that engages with said recess region (5) provided on said flow entry wall part (31), so as to retain said capsule (1) with relation to a sealing element (14) provided so that surrounds said injection means (13).

As can be better observed in the drawing on the right-hand side of FIG. 11, when the brewing device (10) is in a closed position, said injection means (13) are in the interior of recess of said flow entry wall part (31) associated with said passageway wall (4), in particular so that exert a mechanic pressure upon at least part thereof. Said engagement element (15) is in engagement by means of fitting in the recess region (5) of capsule (1), thereby improving the retention and structural reinforcement of said passageway wall (4).

As can be observed in FIG. 12, it is preferred when said engagement element (13) is provided so that develops along an extension of arch of circumference smaller than 20°, preferentially smaller than 15°, and bigger than 3°, preferentially bigger than 5°.

According to another inventive aspect, said sealing element (14) is provided in “O-ring” shape, or similar, in the proximity of said injection means (13) and adapted so as to confine the pressurized fluid flow to the region adjacent to the injection means (13), preferentially so as to additionally conduct said pressurized flow until imping said passageway wall (4) provided in recess relative to said flow entry wall part (31).

Moreover, it is preferred when said sealing element (14) is provided with a ring shape and adapted so that sits on the seat region (61) of said intercalary region (6) between said passageway wall (4) and recess region (5).

It is further preferred when said sealing element (14) is provided as a projection that develops along the axial direction with a smaller extension than the extension of said engagement element (15).

As one can again better observe in the drawing on the right-hand side of FIG. 11, said sealing element (14) ensures conditions of substantial sealing to liquid in the adjacent region, so that the pressurized flow is concentrated in said passageway wall (4), thereby in particular improving the reliability of rupture of respective weakened material region (41).

1. A capsule (1) for preparing an edible product on a brewing device (10), and comprising:
a first construction element (2) configured in a container-like form and adapted so as to provide a collection volume for a single portion of an edible substance, and
a second construction element (3) configured in a circular lid-like form, and adapted so as to confine said collection volume of first construction element (2) and as to provide an entry flow passageway to the interior of said first construction element (2),
whereby said second construction element (3) comprises a flow entry wall part (31) that presents a disk-like general with a prevailing wall thickness (e₃₁) between two plane transversal relative to an axial axis (X) of said flow entry wall part (31),
whereby said flow entry wall part (31) is provided in a rigid material,
whereby said flow entry wall part (31) comprises a passageway wall (4) provided with a circular shape delimited by a first circumferential alignment and disposed centred relative to an axial axis (X) of said capsule (1),
whereby said flow passageway wall (4) presents a weakened material region (41) that develops along at least most part of said first circumferential alignment and that is adapted so that breaks under a given upstream flow pressure, and
whereby said flow entry wall part (31) presents a recess region (5) that develops in the upstream direction from the upstream oriented surface of said flow entry wall part (31),
wherein said capsule (1) being characterized in that said recess region (5) develops from a second circumferential alignment in the proximity of said passageway wall (4) and so that defines an intercalary region (6) between said recess region (5) and said passageway wall (4), whereby said recess region (5) presents a recess wall thickness (e₅) that is smaller than the prevailing wall thickness (e₃₁), and bigger than the passageway wall thickness (e₄) of said passageway wall (4), so that structurally reinforces the region surrounding said passageway wall (4) and provides retention surfaces for an engagement element (15) provided on said brewing device (10).

2. The capsule (1) according to claim 1, characterized in that at least most part, preferentially the totality, of recess thickness (e₅) of said recess region (5) develops between transversal planes in the proximity downstream of the transversal planes that delimit the passageway wall thickness (e₄) of said passageway wall (4), so that at least most part of said recess thickness (e₅) is provided downstream of said passageway wall thickness (e₄).

3. The capsule (1) according to claim 1, characterized
in that said passageway wall (4) is delimited by a first circumferential alignment that presents a first diameter (d₁) smaller than 0.35 times the diameter (d) of said flow entry wall part (31), and
in that said recess region (5) is delimited on a respective distal side by a circumferential alignment presenting a second diameter (d₂), whereby said second diameter (d₂) is at least 1.2 times bigger, preferentially at least 1.4 times bigger, and at most 2.5 times bigger, preferentially at most 2 times bigger than said first diameter (d₁).

4. The capsule (1) according to claim 1, characterized in that the radial extension of said recess region (5) is at least approximately similar, preferentially bigger than 0.8 times and smaller than 1.2 times the radial extension of said intercalary region (6).

5. The capsule (1) according to claim 1, characterized in that said recess region (5) presents a substantially polygonal transversal section defining at least three interior surfaces, preferentially five interior surfaces, and presenting a depth between 1 and 3 mm, preferentially between 1.5 and 2.5 mm, relative to the exterior surface of said second construction element (3), and a radial dimension between 1 and 3 mm, preferentially between 1.5 and 2.5 mm.

6. The capsule (1) according to claim 1, characterized in that said intercalary region (6) presents an intercalary wall thickness (e₆) that is bigger than the passageway wall thickness (e₄) of said passageway wall (4) and bigger than the recess wall thickness (e₅) of said recess region (5), preferentially is at least approximately similar to said prevailing wall thickness (e₃₁), thereby structurally reinforcing the region surrounding said weakened material region (41) and providing a support surface to a sealing element (14) provided on said brewing device (10).

7. The capsule (1) according to claim 1, characterized in that said intercalary region (6) presents an intercalary wall thickness (e₆) that develops between planes transversal to the axial direction upstream and downstream of the transversal planes that delimit said passageway wall thickness (e₄) and recess wall thickness (e₅).

8. The capsule (1) according to claim 1, characterized in that said intercalary region (6) comprises a seat region (61) that develops in the upstream oriented surface of said flow entry wall part (31) along at least most part of the radial extension between said passageway wall (4) and said recess region (5), whereby said seat region (61) is adapted so that provides a seat surface to a sealing element (14) provided on said brewing device (10).

9. The capsule (1) according to claim 1, characterized in that said seat region (61) presents a seat wall thickness (e₆₁) that is bigger than the passageway wall thickness (e₄) of said passageway wall (4), thereby improving the opening of said weakened material region (41) as impinged by an upstream pressurized flow.

10. The capsule (1) according to claim 1, characterized in that said seat region (61) presents a seat wall thickness (e₆₁) that is bigger than the recess wall thickness (e₅) of said recess region (5), preferentially presents a wall thickness that is at least approximately similar to said prevailing wall thickness (e₃₁).

11. The capsule (1) according to claim 1, characterized in that said intercalary region (6) presents a guiding projection (62) along said first circumferential alignment so that delimits said seat region (61) relative to said passageway wall (4), whereby said guiding projection (62) projects beyond the upstream oriented exterior surface of said flow entry wall part (31), so that provides a conduction surface that is adjacent and substantially orthogonal or oblique relative to the surface provided by said seat region (61).

12. System A system for preparing edible products comprising:
a capsule (1) adapted for containing a single portion of an edible substance, in particular a capsule (1) according to claim 1, and
an apparatus for preparing edible products based upon said capsule (1) and including at least one brewing device (10) that presents two actuation parts (11, 12), whereby said capsule (1) comprises an upstream oriented flow entry wall part (31) that presents a passageway wall (4) of circular shape and disposed centred relative to an axial axis (X) of said capsule (1), and successively surrounded by an intercalary region (6) and a recess region (5),
whereby said actuation parts (11, 12) are adapted so as to collect said capsule (1), and at least one of said actuation parts (11, 12) can be moved relative to the other so as to engage with the exterior envelope of said capsule (1),
whereby an upstream actuation part (11) comprises injection means (13) adapted for impinging a pressurized fluid flow upon said passageway wall (4) provided on an upstream oriented side of said capsule (1),
whereby a downstream actuation part (12) comprises discharge means adapted for collecting a beverage from the downstream oriented side of said capsule (1), and
whereby said upstream actuation part (11) presents a sealing element (14) and one engagement element (15) adapted so as to cooperate with respective regions of said flow entry wall part (31) of capsule (1), and
wherein said system being characterized in that said upstream actuation part (11) presents an engagement element (15) provided as a protuberance that develops at a distance from said injection means (13) and adapted so that engages on said recess region (5) provided on said flow entry wall part (31), so as to retain said capsule (1) with relation to a sealing element (14) provided so that surrounds said injection means (13).

13. The system according to claim 12, characterized in that said engagement element (13) is provided so that develops along an extension of arch of circumference smaller than 20°, preferentially smaller than 15°, and bigger than 3°, preferentially bigger than 5°.

14. The system according to claim 12, characterized in that said sealing element (14) is provided in “O-ring” shape, or similar, in the proximity of said injection means (13) and adapted so as to confine the pressurized fluid flow to the region adjacent to the injection means (13), preferentially so as to additionally conduct said pressurized flow until imping said passageway wall (4) provided in recess relative to said flow entry wall part (31).

15. The system according to claim 12, characterized in that said sealing element (14) is provided with a ring shape and adapted so that sits on the seat region (61) of said intercalary region (6) between said passageway wall (4) and recess region (5).

16. The system according to claim 12, characterized in that said sealing element (14) is provided as a projection that develops along the axial direction with a smaller extension than the extension of said engagement element (15).
